(19) United States
(12) Patent Application Publication
(10) Pub. No.: US 2024/0158876 A1
(43) Pub. Date: May 16, 2024

(54) METHOD FOR EVALUATING ENERGY EFFICIENCY OF ELECTRIC ARC FURNACE STEELMAKING

(71) Applicant: University of Science and Technology Beijing, Beijing (CN)

(72) Inventors: Guangsheng WEI, Beijing (CN); Hongjing ZHANG, Beijing (CN); Rong ZHU, Beijing (CN); Afan XU, Beijing (CN); Yu CHEN, Beijing (CN); Ruimin ZHAO, Beijing (CN); Kai DONG, Beijing (CN); Bohan TIAN, Beijing (CN); Botao XUE, Beijing (CN); Chao FENG, Beijing (CN)

(73) Assignee: University of Science and Technology Beijing, Beijing (CN)

(21) Appl. No.: 18/459,388

(22) Filed: Aug. 31, 2023

(30) Foreign Application Priority Data
Nov. 9, 2022 (CN) 202211395767.X

(51) Int. Cl. C21C 5/52

(52) U.S. Cl. CPC C21C 5/52; C21C 2005/5288

(57) ABSTRACT

A method for evaluating energy efficiency of electric arc furnace steelmaking comprises: obtaining original smelting information of the electric arc furnace; processing the original smelting information, and calculating an electrical energy efficiency evaluation index and a chemical energy efficiency evaluation index for process operation; wherein the electrical energy efficiency evaluation index comprises circuit efficiency, transformer tap capacity utilization rate and electrical energy thermal efficiency, and the chemical energy efficiency evaluation index comprises oxygen utilization rate, carbon powder utilization rate and chemical energy thermal efficiency; and evaluating an energy utilization condition of the electric arc furnace comprehensively based on the electrical energy efficiency evaluation index and the chemical energy efficiency evaluation index. According to the method, a basis can be provided for subsequent smelting process adjustment, and the energy utilization efficiency of the electric arc furnace is improved.

### CROSS-REFERENCE TO RELATED APPLICATIONS

This application claims the priority of the Chinese application No. 202211395767.X with a filing date of Nov. 9, 2022. The content of the aforementioned applications, including any intervening amendments thereto, is incorporated herein by reference.

### TECHNICAL FIELD

The present disclosure relates to the technical field of electric arc furnace steelmaking, in particular to a method for evaluating energy efficiency of electric arc furnace steelmaking.

### BACKGROUND

Electric arc furnace is one of the important equipment for steelmaking in a short process. The steelmaking process of the electric arc furnace is a complex process of multi-phase reactions at high temperature, electrical energy and chemical energy both being important energy sources. The electrical energy is mainly provided by the electric arc generated by the power supply system in the furnace, and the chemical energy is mainly provided by the oxygen lance spraying oxygen into the molten pool to generate various oxidation reactions. Reasonable power supply and oxygen supply system is important for efficient smelting in the electric arc furnace. In the current production of the electric arc furnace, power supply, oxygen supply and carbon injection are often operated manually. Due to the hysteresis of detection and control means, the operation of the power supply and the oxygen supply is unreasonable, resulting in low utilization efficiency of electrical energy and chemical energy in the smelting process. This not only leads to a large loss of the electrical energy and the chemical energy, but also increases the material loss, and also slows down the smelting process and increases production costs, resulting in the low competitiveness of electric arc furnaces. Therefore, improving the production efficiency of the electric arc furnaces and reducing energy waste is one of the important directions for the development of the electric arc furnace technology in the future. Moreover, an existing method for evaluating energy efficiency of electric arc furnaces often only assesses the energy consumption of the overall production of the electric arc furnaces, which can only be used to evaluate the current energy consumption, and does not assess the particular process operation, so cannot be used for energy efficiency improvement.

### SUMMARY

Embodiments of the present disclosure provide a method for evaluating energy efficiency of electric arc furnace steelmaking, which can be a basis for the adjustment of the subsequent smelting process and improve the energy utilization efficiency of the electric arc furnace. The technical solutions provided by the present disclosure are as follows:

In one aspect, a method for evaluating energy efficiency of electric arc furnace steelmaking is provided. The method is used to electronic equipment, and includes:
obtaining original smelting information of the electric arc furnace;
processing the original smelting information, and calculating an electrical energy efficiency evaluation index and a chemical energy efficiency evaluation index for process operation; wherein, the electrical energy efficiency evaluation index includes: circuit efficiency, transformer tap capacity utilization rate and electrical energy thermal efficiency, and the chemical energy efficiency evaluation index includes: oxygen utilization rate, carbon powder utilization rate and chemical energy thermal efficiency; and
evaluating an energy utilization condition of the electric arc furnace comprehensively, based on the electrical energy efficiency evaluation index and the chemical energy efficiency evaluation index.

Further, before obtaining the original smelting information of the electric arc furnace, the method includes:
obtaining the original smelting information by collecting information of raw materials and auxiliary materials, end point information and smelting process information of the electric arc furnace by a smelting data collection mechanism.

Further, the information of raw materials and auxiliary materials includes: ingredients, temperature, addition time and addition amount of the raw materials and the auxiliary materials.

The end point information includes: end point temperature, end point ingredient and tapping weight.

The smelting process information includes: voltage and current, transformer tap information, power consumption, power, oxygen consumption, oxygen supply intensity, carbon injection amount, carbon injection speed, molten pool temperature measurements, and molten pool sampling analysis.

Further, the processing the original smelting information includes:
data screening and processing on the original smelting information, and removing missing, repeated and abnormal data points; and
establishing the equivalent circuit model, mass balance model and energy balance model of the electric arc furnace by screening the data to determine the mass and energy consumption data of the electric arc furnace, thus reflecting the mass and energy consumption of the electric arc furnace.

Further, the circuit efficiency is expressed as:

$${η}_{D 1} = \frac{{P}_{E} - {I}_{arc}^{2} {R}_{sc}}{{P}_{E}} \times 100 \%$$

wherein, η_{D1} represents the circuit efficiency used to define electricity loss of power supply line of the electric arc furnace; P_{E} represents single-phase power of the electric arc furnace; I_{arc} represents single-phase current of the electric arc furnace; R_{sc} represents equivalent short-circuit resistance of secondary side of the electric arc furnace.

Further, the transformer tap capacity utilization rate is expressed as:

$${η}_{D 2} = \frac{{P}_{Ea}}{{P}_{set}} \times 100 \%$$

wherein, η_{D2} represents the transformer tap capacity utilization rate used to define arc stability of the electric arc furnace; P_{Ea} represents total power of the electric arc furnace; Pₛₑₜ represents preset total output power of current transformer tap.

Further, the electrical energy thermal efficiency is expressed as:

$${η}_{D 3} = \frac{{W}_{ES}}{{W}_{E}} \times 100 \%$$

wherein, η_{D3} represents the electrical energy thermal efficiency used to define the electrical energy thermal efficiency input into the electric arc furnace actually used for scrap steel melting and slag steel heating; W_{ES} represents effective electrical energy accepted by the scrap steel melting and the slag steel heating; W_{E} represents total electrical energy input into the electric arc furnace during calculation.

Further, the oxygen utilization rate is expressed as:

$${η}_{C 1} = \frac{{μ}_{{0}_{2}} \times {V}_{id - {O}_{2}}}{{V}_{{O}_{2}}} \times 100 \%$$

wherein, η_{C1} represents the oxygen utilization rate used to define actual utilization of oxygen supply of the electric arc furnace; V_{O}_{₂} represents oxygen supply amount of the electric arc furnace; μ_{O}_{₂} represents oxygen supply ratio of oxygen lance inside the electric arc furnace; V_{id-O}_{₂} represents theoretical oxygen amount of the electric arc furnace used for reaction.

Further, the carbon powder utilization rate is expressed as:

$${η}_{C 2} = \frac{{m}_{id - C} - {m}_{SC}}{{m}_{C}} \times 100 \%$$

wherein, η_{C2} represents the carbon powder utilization rate used to define utilization efficiency of carbon injection in the electric arc furnace; m_{C} represents carbon injection amount in the electric arc furnace; m_{id-C} represents carbon amount consumed by theoretical reaction in the electric arc furnace; m_{SC} represents carbon amount consumed in the molten pool of the electric arc furnace.

Further, the chemical energy thermal efficiency is expressed as:

$${η}_{C 3} = \frac{{W}_{GE} - {W}_{LR} - {η}_{D 3} \times {W}_{E}}{{W}_{CH}} \times 100 \%$$

wherein, η_{C3} represents the chemical energy thermal efficiency used to define energy efficiency of chemical reaction in the electric arc furnace actually used for scrap steel melting and slag steel heating; W_{GE} represents effective energy accepted by the scrap steel melting and the slag steel heating; W_{LR} represents physical heat brought by raw materials; W_{CH} represents total energy of the chemical reaction in molten pool; η_{D3} represents the electrical energy thermal efficiency; W_{E} represents total electrical energy input into the electric arc furnace during calculation.

In another aspect, an electronic device is provided, which includes a processor and a memory, and the memory is stored with at least one instruction, and the at least one instruction is loaded and executed by the processor to implement the above method for evaluating the energy efficiency of the electric arc furnace steelmaking.

In another aspect, a computer-readable storage medium is provided. At least one instruction is stored in the computer-readable storage medium, and the at least one instruction is loaded and executed by the processor to implement the above method for evaluating the energy efficiency of the electric arc furnace steelmaking.

The technical solutions provided by the embodiments of the present disclosure at least have the following beneficial effects:

In the embodiments of the present disclosure, in regard to process operation, the energy utilization condition in the smelting process of the electric arc furnace is quantitatively analyzed by calculating energy efficiency, so that the operator can fully understand the energy consumption condition and operation level of the electric arc furnace. The analysis results show the weak factors that have a great impact on the production of the electric arc furnace, which can provide a basis for the subsequent adjustment of the smelting process, and help to improve the efficiency in the subsequent smelting process, thereby reducing energy loss and improving the smelting process and the energy utilization efficiency of the electric arc furnace, and improving the production level of the electric arc furnace.

### BRIEF DESCRIPTION OF THE DRAWINGS

In order to more clearly illustrate the technical solutions in the embodiments of the present disclosure, the drawings that need to be used in the description of the embodiments will be briefly introduced below. Obviously, the drawings in the following description are only some embodiments of the present disclosure. For those skilled in the art, other drawings can also be obtained based on these drawings without creative effort.

FIG. 1 is a schematic flow chart showing a method for evaluating energy efficiency of electric arc furnace steelmaking according to one embodiment of the present disclosure; and

FIG. 2 is a schematic structural diagram showing an electronic device according to one embodiment of the present disclosure.

### DETAILED DESCRIPTION

In order to make the objects, technical solutions and advantages of the present disclosure clearer, the implementations of the present disclosure will be further described in detail below in conjunction with the accompanying drawings.

The embodiment of the present disclosure provides a method for evaluating energy efficiency, specifically energy utilization efficiency of electric arc furnace steelmaking. This method is applicable to the electric arc furnaces with nominal capacity between 50-300 t, using charging materials of full scrap steel or hot iron added with scrap steel or scrap steel added with direct reduced iron, and with furnace type of top charging or horizontal continuous charging or shaft furnace. In order to understand the present disclosure better, taking its application in the steelmaking of 100 t top charging electric arc furnace as an example, and described in detail, the electric arc furnace transformer capacity is 72 MVA, is equipped with three oxygen lances on the furnace wall, and the maximum oxygen supply capacity is 10200 Nm³/h.

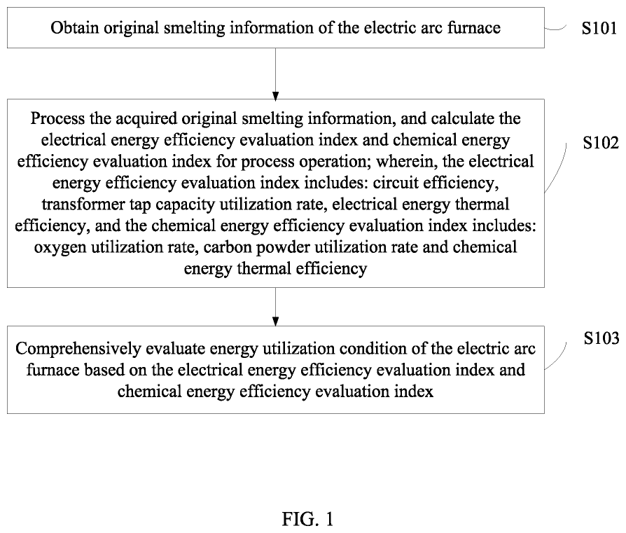

As shown in FIG. 1, the method for evaluating the energy efficiency of the electric arc furnace steelmaking according to the embodiment of the present disclosure may specifically include the following steps:

S101, obtaining original smelting information of the electric arc furnace.

In this embodiment, information of raw materials and auxiliary materials, end point information and smelting process information of the electric arc furnace are collected by a smelting data collection mechanism to obtain the original smelting information.

In this embodiment, the smelting data collection mechanism mainly refers to such smelting data collection mechanism as a power quality analyzer installed on primary side of the electric arc furnace transformer, an electrode adjustment system PLC group, an oxygen supply control PLC group, a carbon injection control PLC group and temperature measuring PLC group of the electric arc furnace.

In this embodiment, the information of raw materials and auxiliary materials includes information on the ingredients, temperature, addition time and addition amount of the raw materials and auxiliary materials such as scrap steel, hot iron, and pig iron.

In this embodiment, the end point information includes: end point temperature, end point ingredient and tapping weight.

In this embodiment, the smelting process information includes: voltage and current, transformer tap information, power consumption, power, oxygen consumption, oxygen supply intensity, carbon injection amount, carbon injection speed, molten pool temperature measurements, and molten pool sampling analysis.

In this embodiment, it is assumed that the main production information of the current furnace is as follows:

The raw material of this furnace is 49% hot iron and 51% scrap steel, added with 3.5 t lime and 1.5 t lightly burned dolomite, and the smelting cycle is 38 minutes. After sampling and temperature measurement at the end point, the tapping temperature is 1640° C., and the C content at the end point is 0.08%. The power consumption level is 156 kWh/t, the maximum power supply tap is tap 12, and an average power is 56.3 MW. The oxygen consumption level per ton of steel is 39.3 Nm³/t, and the carbon consumption level per ton of steel is 2.6 kg/t. During the smelting process, the curves of the power supply and oxygen supply are carried out by the power quality analyzer and PLC mechanism, and the composition and charging temperature of raw materials are shown in Table 1.

TABLE 1
the ingredients and charging temperature of the raw materials

| | | | | | | Charging |
|---|---|---|---|---|---|---|
| Raw | | | | | | temperature/ |
| materials | C/% | Si/% | Mn/% | P/% | S/% | ° C. |
| Molten | 4.20 | 0.80 | 0.60 | 0.200 | 0.035 | 1348 |
| steel | | | | | | |
| Scrap | 0.18 | 0.25 | 0.55 | 0.030 | 0.030 | 25 |
| steel | | | | | | |

S102, processing the acquired original smelting information, and calculating the electrical energy efficiency evaluation index and chemical energy efficiency evaluation index for process operation; wherein, the electrical energy efficiency evaluation index includes: circuit efficiency, transformer tap capacity utilization rate, electrical energy thermal efficiency, and the chemical energy efficiency evaluation index includes: oxygen utilization rate, carbon powder utilization rate and chemical energy thermal efficiency.

In this embodiment, processing the original smelting information may specifically include the following steps:

A1. Data screening and processing on the original smelting information, and removing missing, repeated and abnormal data points, which refer to data points that are obviously deviated from normal values.

In this embodiment, the power supply measurement data points of the electric arc furnace are subjected to Gaussian smoothing with a window of 10 to remove the abnormal data points that fluctuate too significantly. The abnormal oxygen supply data points caused by the flow fluctuation when the oxygen lance is turned on or off are subjected to smooth processing, and the abnormal temperature data caused by operation problems during the temperature measurement and sampling process is removed, and the empty component data caused by uneven sampling is removed.

A2. Establishing an equivalent circuit model, a mass balance model and an energy balance model of the electric arc furnace based on the screened data, and determining the material and energy consumption data of the electric arc furnace by the equivalent circuit model, the mass balance model and the energy balance model of the electric arc furnace, which reflect the material and energy consumption of the electric arc furnace.

A method for evaluating energy efficiency of the electric arc furnace steelmaking proposed in the embodiments of the present disclosure is divided into electrical energy efficiency evaluation and chemical energy efficiency evaluation based on the energy source; wherein, the indicators used to evaluate the electrical energy efficiency include: circuit efficiency, transformer tap capacity utilization rate and electrical energy thermal efficiency.

In this embodiment, the circuit efficiency is expressed as:

$${η}_{D 1} = \frac{{P}_{E} - {I}_{arc}^{2} {R}_{sc}}{{P}_{E}} \times 100 \%$$

wherein, η_{D1} represents the circuit efficiency used to define electricity loss of power supply line of the electric arc furnace; P_{E} represents single-phase power of the electric arc furnace, which is 18.7 MW in this embodiment; I_{arc} represents single-phase current of the electric arc furnace, which is 48.6 kA in this embodiment; P_{E} and I_{arc} can be obtained by the power quality analyzer; R_{sc} represents equivalent short-circuit resistance of secondary side of the electric arc furnace, calculated by the equivalent circuit model of the electric arc furnace, which is 0.47 mΩ in this embodiment.

Therefore, the circuit efficiency η_{D1} of the electric arc furnace is calculated as: RDη_{D1}=94.1%

In this embodiment, the transformer tap capacity utilization rate is expressed as:

$${η}_{D 2} = \frac{{P}_{Ea}}{{P}_{set}} \times 100 \%$$

wherein, η_{D}2 represents the transformer tap capacity utilization rate used to define arc stability of the electric arc furnace; P_{Ea} represents total power of the electric arc furnace collected by the power quality analyzer, which is 56.3 MW in this embodiment; Pₛₑₜ represents preset total output power of current transformer tap given by the electrode adjustment system PLC group of the electric arc furnace, which is 57.9 MW in this embodiment.

Therefore, the transformer tap capacity utilization rate η_{D2} of the electric arc furnace is calculated as: η_{D2}=97.2%

In this embodiment, the electrical energy thermal efficiency is expressed as:

$${η}_{D 3} = \frac{{W}_{ES}}{{W}_{E}} \times 100 \%$$

wherein, η_{D3} represents the electrical energy thermal efficiency used to define the electrical energy thermal efficiency input into the electric arc furnace actually used for scrap steel melting and slag steel heating; W_{ES} represents effective electrical energy accepted by the scrap steel melting and the slag steel heating, which is 106.6 kWh/t in this embodiment, calculated from mass balance and energy balance; W_{E} represents total electrical energy input into the electric arc furnace during calculation, measured by a power quality analyzer, which is 156.3 kWh/t in this embodiment.

Therefore, the electric thermal efficiency η_{D3} of the electric arc furnace is calculated as: η_{D3}=68.1%

In this embodiment, the indicators used to evaluate the chemical energy efficiency include: oxygen utilization rate, carbon powder utilization rate and chemical energy thermal efficiency.

In this embodiment, the oxygen utilization rate is expressed as:

$${η}_{C 1} = \frac{{μ}_{{O}_{2}} \times {V}_{id - {O}_{2}}}{{V}_{{O}_{2}}} \times 100 \%$$

wherein, η_{C1} represents the oxygen utilization rate used to define actual utilization of oxygen supply of the electric arc furnace; V_{O}_{₂} represents oxygen supply amount of the electric arc furnace, given by the oxygen supply control PLC group of the electric arc furnace, which is 39.3 Nm³/t in this embodiment; μ_{O}_{₂} represents oxygen supply ratio of oxygen lance inside the electric arc furnace, determined based on the seal and the negative pressure situation of the furnace body, which is 0.8 in this embodiment; V_{id-O}_{₂} represents theoretical oxygen amount of the electric arc furnace used for reaction, calculated by the mass balance model, which is 42.6 Nm³/t in this embodiment.

Therefore, the oxygen utilization rate η_{C1} of the electric arc furnace is calculated as: η_{C1}=87.4%.

In this embodiment, the carbon powder utilization rate is expressed as:

$${η}_{C 2} = \frac{{m}_{id - C} - {m}_{SC}}{{m}_{C}} \times 100 \%$$

wherein, η_{C2} represents the carbon powder utilization rate used to define utilization efficiency of carbon injection in the electric arc furnace; m_{C} represents carbon injection amount in the electric arc furnace, given by the carbon injection control PLC group of the electric arc furnace, which is 2.6 kg/t in this embodiment; m_{id-C} represents carbon amount consumed by theoretical reaction in the electric arc furnace, which is 22.57 kg/t in this embodiment; m_{SC} represents carbon amount consumed in the molten pool of the electric arc furnace, calculated by the mass balance model, which is 20.67 kg/t in this embodiment.

Therefore, the carbon powder utilization rate η_{C2} of the electric arc furnace is calculated as: η_{C1}=73.1%.

In this embodiment, the chemical energy thermal efficiency η_{C3} describes the energy efficiency of chemical reaction in the electric arc furnace actually used for scrap steel melting and slag steel heating, calculated by the following formula

$${η}_{C 3} = \frac{{W}_{GE} - {W}_{LR} - {η}_{D 3} \times {W}_{E}}{{W}_{CH}} \times 100 \%$$

wherein, η_{C3} represents the chemical energy thermal efficiency used to define energy efficiency of chemical reaction in the electric arc furnace actually used for scrap steel melting and slag steel heating; W_{GE} represents effective energy accepted by the scrap steel melting and the slag steel heating, which is 439.5 kWh/t in this embodiment; W_{LR} represents physical heat brought by the raw material, which is 210.3 kWh/t in this embodiment; W_{CH} represents total energy of the chemical reaction in molten pool, which is 301.5 kWh/t in this embodiment; W_{GE}, W_{CH} and W_{E} are all calculated by mass balance and energy balance; η_{D3} represents the electrical energy thermal efficiency, determined by the formula

$${η}_{D 3} = \frac{{W}_{ES}}{{W}_{E}} \times 100 \% ,$$

which is 68.1%; W_{E} represents total electrical energy input into the electric arc furnace during calculation, measured by a power quality analyzer, which is 156.3 kWh/t in this embodiment.

Therefore, the chemical energy thermal efficiency η_{C3} of the electric arc furnace is calculated as: η_{C3}=40.7%

S103, comprehensively evaluating energy utilization condition of the electric arc furnace based on the electrical energy efficiency evaluation index and chemical energy efficiency evaluation index.

In this embodiment, the energy efficiency calculation results of the electric arc furnace are shown in Table 2.

TABLE 2
Calculation results of energy efficiency

| Electrical | Energy | Chemical | Energy |
|---|---|---|---|
| energy | efficiency | energy | efficiency |
| efficiency | result/% | efficiency | result/% |
| Circuit | 94.1 | Oxygen utilization | 87.4 |
| efficiency η_{D1} | | rate η_{C1} | |
| Transformer tap | 97.2 | Carbon powder | 73.1 |
| capacity utilization | | utilization | |
| rate η_{D2} | | rate η_{C2} | |
| Electrical | 68.1 | Chemical | 40.7 |
| energy thermal | | energy thermal | |
| efficiency η_{D3} | | efficiency η_{C3} | |

It can be seen from Table 2 that the circuit efficiency of the electric arc furnace is high, and the transformer tap capacity utilization rate is also high, indicating that its power supply operation is good and the arc stability is high. However, the electrical energy thermal efficiency of the electric arc furnace is poor, and the chemical energy thermal efficiency of the electric arc furnace is relatively low, resulting in a high level of total production energy consumption. Since the oxygen utilization rate of the electric arc furnace is at a normal level and the carbon powder utilization rate is normal, which may be the reason that the chemical reaction and heat conduction are not uniform due to poor stirring in the furnace, and the heat dissipation is serious, the effective utilization rate of electrical energy and chemical energy is low. Therefore, the stirring level in the furnace is improved by bottom blowing or improving the layout of the oxygen lance to improve the energy efficiency.

The method for evaluating the energy efficiency of electric arc furnace steelmaking provided by the embodiment of the present disclosure is a method for comprehensively evaluating the energy efficiency level during the operation of the electric arc furnace, and has at least the following beneficial effects:

For process operation, the specific definition and calculation method of the energy efficiency of the electric arc furnace are proposed, and used as an evaluation standard to conduct a specific quantitative analysis of the energy utilization in the smelting process of the electric arc furnace by energy efficiency calculation, so that the operator can comprehensively understand the energy consumption and operation status of the electric arc furnace, and the analysis results reflect the weak factors that have a significant impact on the production of the electric arc furnace, which can provide a basis for the subsequent adjustment of the smelting process and help to improve the efficiency, reduce energy loss, improve the smelting process and energy utilization efficiency of electric arc furnace, and improve the production level of electric arc furnace.

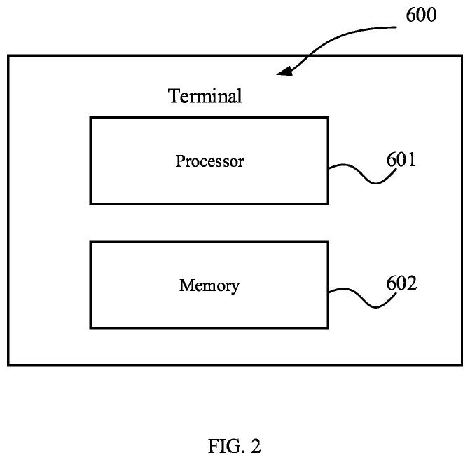

FIG. 2 is a schematic structural diagram of an electronic device 600 provided by one embodiment of the present disclosure. The electronic device 600 may have relatively large differences due to different configurations or performances, and may include one or more central processing units (CPU) 601 and one or more memories 602, wherein the memory is stored with at least one instruction 602, and the at least one instruction is loaded and executed by the processor 601 to implement the above-mentioned method for evaluating energy efficiency of electric arc furnace steelmaking.

In an exemplary embodiment, a computer-readable storage medium is provided, such as a memory including instructions, which can be executed by a processor in a terminal to complete the above method for evaluating the energy efficiency of the electric arc furnace steelmaking. For example, the computer readable storage medium may be ROM, random access memory (RAM), CD-ROM, magnetic tape, floppy disk, optical data storage device, and the like.

Those skilled in the art can understand that all or part of the steps for implementing the above embodiments can be completed by hardware, and can also be completed by instructing related hardware through a program. The program can be stored in a computer-readable storage medium. The above-mentioned storage medium may be a read-only memory, a magnetic disk or an optical disk, and the like.

The above descriptions are only preferred embodiments of the present disclosure, and are not intended to limit the present disclosure. Any modifications, equivalent replacements, improvements, etc. made within the spirit and principles of the present disclosure shall fall within the protection scope of the appended claims.

What is claimed is:

1. A method for evaluating energy efficiency of electric arc furnace steelmaking, comprising:
obtaining original smelting information of the electric arc furnace;
processing the original smelting information, and calculating an electrical energy efficiency evaluation index and a chemical energy efficiency evaluation index for process operation; wherein, the electrical energy efficiency evaluation index comprises: circuit efficiency, transformer tap capacity utilization rate and electrical energy thermal efficiency, and the chemical energy efficiency evaluation index comprises: oxygen utilization rate, carbon powder utilization rate and chemical energy thermal efficiency; and
evaluating an energy utilization condition of the electric arc furnace based on the electrical energy efficiency evaluation index and the chemical energy efficiency evaluation index;
wherein, the line efficiency is expressed as:
$${η}_{D 1} = \frac{{P}_{E} - {I}_{arc}^{2} {R}_{sc}}{{P}_{E}} \times 100 \%$$
wherein, η_{D1} represents the line efficiency used to define electricity loss of power supply line of the electric arc furnace; P_{E} represents single-phase power of the electric arc furnace; I_{arc} represents single-phase current of the electric arc furnace; R_{sc} represents equivalent short-circuit resistance of secondary side of the electric arc furnace.

2. The method according to claim 1, wherein, before obtaining the original smelting information of the electric arc furnace, the method comprises:
obtaining the original smelting information by collecting information of raw materials and auxiliary materials, end point information and smelting process information of the electric arc furnace by a smelting data collection mechanism.

3. The method according to claim 2, wherein the information of raw materials and auxiliary materials comprises: ingredients, temperature, addition time and addition amount of the raw materials and the auxiliary materials;
the end point information comprises: end point temperature, end point ingredient and tapping weight;
the smelting process information comprises: voltage and current, transformer tap information, power consumption, power, oxygen consumption, oxygen supply intensity, carbon injection amount, carbon injection speed, molten pool temperature measurements, and molten pool sampling analysis.

4. The method according to claim 1, wherein processing the original smelting information comprises:
data screening and processing on the original smelting information, and removing missing, repeated and abnormal data points;
establishing an equivalent circuit model, a mass balance model and an energy balance model of the electric arc furnace based on the screened data, and determining material and energy consumption data of the electric arc furnace by the equivalent circuit model, the mass balance model and the energy balance model of the electric arc furnace, thus indicating the material and energy consumption of the electric arc furnace.

5. The method according to claim 1, wherein the transformer tap capacity utilization rate is expressed as:
$${η}_{D 2} = \frac{{P}_{Ea}}{{P}_{set}} \times 100 \%$$
wherein, η_{D2} represents the transformer tap capacity utilization rate used to define arc stability of electric arc furnace; P_{Ea} represents total power supply of the electric arc furnace; Pₛₑₜ represents preset total output power of current transformer tap.

6. The method according to claim 1, wherein the electrical energy thermal efficiency is expressed as:
$${η}_{D 3} = \frac{{W}_{ES}}{{W}_{E}} \times 100 \%$$
wherein, η_{D3} represents the electrical energy thermal efficiency used to define the electrical energy thermal efficiency input into the electric arc furnace actually used for scrap steel melting and slag steel heating; W_{ES} represents effective electrical energy accepted by the scrap steel melting and the slag steel heating; W_{E} represents total electrical energy input into the electric arc furnace during calculation.

7. The method according to claim 1, wherein the oxygen utilization rate is expressed as:
$${η}_{C 1} = \frac{{μ}_{{O}_{2}} \times {V}_{id - {O}_{2}}}{{V}_{{O}_{2}}} \times 100 \%$$
wherein, η_{C1} represents the oxygen utilization rate used to define actual utilization of oxygen supply of the electric arc furnace; V_{O}_{₂} represents oxygen supply amount of the electric arc furnace; μ_{O}_{₂} represents oxygen supply ratio of oxygen lance inside the electric arc furnace; V_{id-O}_{₂} represents theoretical oxygen amount of the electric arc furnace used for reaction.

8. The method according to claim 1, wherein, the carbon powder utilization rate is expressed as:
$${η}_{C 2} = \frac{{m}_{id - C} - {m}_{SC}}{{m}_{C}} \times 100 \%$$
wherein, η_{C2} represents the carbon powder utilization rate used to define utilization efficiency of carbon injection in the electric arc furnace; m_{C} represents carbon injection amount in the electric arc furnace; m_{id-C} represents carbon amount consumed by theoretical reaction in the electric arc furnace; m_{SC} represents carbon amount consumed in the molten pool of the electric arc furnace.

9. The method according to claim 1, wherein, the chemical energy thermal efficiency is expressed as:
$${η}_{C 3} = \frac{{W}_{GE} - {W}_{LR} - {η}_{D 3} \times {W}_{E}}{{W}_{CH}} \times 100 \%$$
wherein, η_{C3} represents the chemical energy thermal efficiency used to define energy efficiency of chemical reaction in the electric arc furnace actually used for scrap steel melting and slag steel heating; W_{GE} represents effective energy accepted by the scrap steel melting and the slag steel heating; W_{LR} represents physical heat brought by raw materials; W_{CH} represents total energy of the chemical reaction in molten pool; η_{D3} represents the electrical energy thermal efficiency; W_{E} represents total electrical energy input into the electric arc furnace during calculation.
